(19) United States
(12) Patent Application Publication
(10) Pub. No.: US 2019/0137722 A1
(43) Pub. Date: May 9, 2019

(54) Filter System for Ultra Wide Angle Lenses

(71) Applicant: James Patrick Hennessy, Campbell, CA (US)

(72) Inventor: James Patrick Hennessy, Campbell, CA (US)

(21) Appl. No.: 15/808,681

(22) Filed: Nov. 9, 2017

(51) Int. Cl. G02B 7/00; G03B 11/00

(52) U.S. Cl. CPC G02B 7/006; G03B 11/00

(57) ABSTRACT

A camera filter apparatus that allows attachment to a wide or ultra wide angle lens that is not meant to accept filters or has no filter threads for a conventional filter to attach to. This camera filter apparatus has a planar lens filter component that is shaped in a way that is best described as a circle with a rectangle superimposed across the center lengthwise in the x direction. This assures filter coverage. Two features called standoffs are located at the north and south of the circular geometry. These have two purposes. The first is to locate the plane of the filter so it fits close, but not touching, the front lens element. The second purpose is to employ a means of friction with the inside of the longer scallops, to hold the filter apparatus in place.

### BACKGROUND

Some wide angle lenses and most ultra wide angle lenses have no filter threads as it is impractical for the following reasons. First, the fact that it is a wide angle lens, means that the filter area needs to be larger to cover the the wide angle of view. Secondly, the protruding front element (common with ultra wide angle lenses), would require the filter to be positioned too far away from the lens. This exacerbates the first reason as the further away from the front element, the larger the filter would have to be, to cover the angle of view. Conventional approaches to this problem, incorporate some type of apparatus that attaches to the outside of the lens hood (also called lens shade). The conventional apparatus would also incorporate means to hold a very large square or rectangular filter in front of the lens. The issues to this approach is follows:

The conventional apparatus has to be assembled (usually in the field) and takes time.

Most Ultra Wide lenses, that don't have filter threads, have built in scalloped lens shades built in. Conventional filters need to be placed in front of the longest section or longest two scallops. When looking at the front of the lens, with the camera in normal landscape position, the longer scallops are in the y direction or North South, and the shorter scallops are in the x direction or East West. This allows the possibility of light entering on the side and reflecting off the inner (lens side) surface of the filter. When using multi stop neutral density filters, forward light is cut, making the exposure longer. If a possibility of side light exists, the situation worsens with longer exposure, as the side light is not filtered out.

Another approach, to using a filter with a wide angle lens, is to mount the filter at the rear of the lens. This is a good choice with film cameras. With digital cameras, the practice of removing a lens, installing a filter and replacing a lens, introduces the possibility of dust to enter the camera body, and the back of the lens. This is a problem because of the dust finding its way to the sensor and causing dust spots in the image.

### SUMMARY OF THE INVENTION

A filter and apparatus with mounting features that allow mounting to the inside of the lens hood of a wide or ultra wide angle lens without the use of filter threads.

### BRIEF EXPLANATION OF DRAWINGS

FIG. 1: This shows the filter apparatus in the direction away from the lens. Note the two stand-offs that provide proper spacing relative to the front element as well as frictional forces to the inside of the lens hood

FIG. 2: This shows the filter apparatus in the direction towards front of the lens

FIG. 3: This shows the filter apparatus in the process of attaching it the the lens

FIG. 4: This shows front and side views with references to critical dimensions

FIG. 5: This is a cutaway drawing that shows the field of view when the apparatus is attached to the lens

FIG. 6: This shows detail of the standoff with spring mechanism employed

FIG. 7: A slightly different view from FIG. 6 of the standoff

FIG. 8: A shaded view of the standoff with more detail on the spring mechanism

FIG. 9: This shows the opposite side of the standoff

### DETAILED DESCRIPTION

The present disclosure is generally directed to a custom filter that uses mounting stand-offs allowing it to attach to the scallops shown in FIG., items 3 and 37, of an ultra wide angle lens hood by means of frictional forces. Most ultra wide angle lenses made for DSLR cameras, do not have filter threads as the front element of the lens protrudes too far to allow for it. This differs from current approaches of mounting a filter in front of an ultra wide angle lens in many ways. The main difference is that the user is presented with a single piece to attach, as opposed to assembling an apparatus to the lens in which to hold a filter in place. To accomplish this, the filter must be dimensionally created for specific lenses. The area of attachment would be the inside of the two longer sections of the scalloped lens hood.

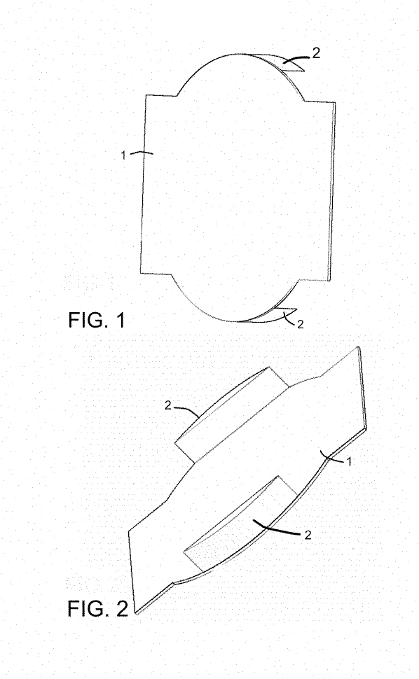

FIG. 1 and FIG. 2 depicts the front and back views of the apparatus. The filter or substrate 1, can be made from glass or polycarbonate material. Item 2 (two places) are the stand offs.

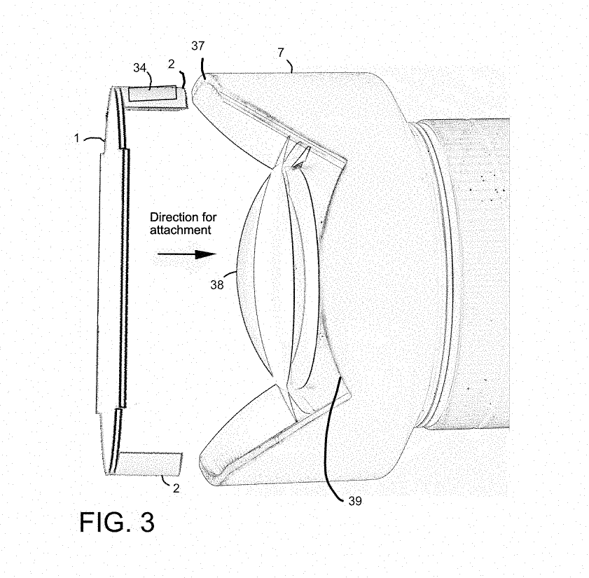

FIG. 3 depicts the apparatus and an ultra wide angle lens hood 7. This shows the apparatus in the proper orientation to attach to the lens. As the apparatus is placed into the front of the lens, the standoffs 2 will interfere slightly with the longer two scallops 37 (two places) inside diameter. The actual contact is the friction pad 34. In other embodiments, the friction is created with a spring like mechanism that will be discussed later. The standoffs 2 will not allow the substrate 1 to hit the front element of the lens, and will position the substrate 1 in front of the shorter two scallops on the side 39 (two places).

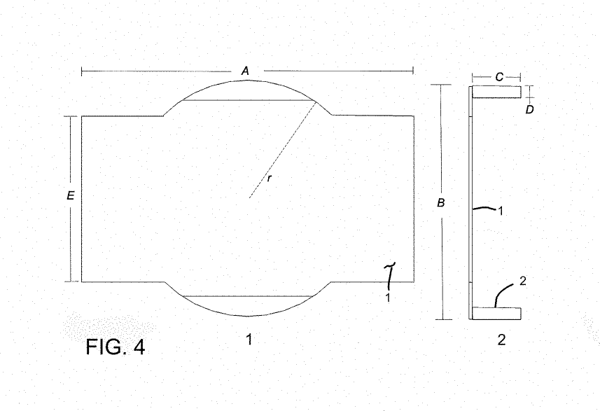

The important dimensions are displayed in FIG. 4. Dimension A, of the substrate, must extend beyond the shorter scallops. Additional length is given for handling the device in attaching or removing it from the lens using a thumb and forefinger. Dimension B is described later in the specification, and is generally slightly smaller than the inside diameter of the lens hood. Dimensions C and D define the location of the substrate plane and are also discussed later in the specification. Dimension E is the distance between the two larger hood scallops at the plane location of the substrate when mounted to the lens. A small amount 1 to 2 mm are subtracted to reduce the chance of hitting the scallops.

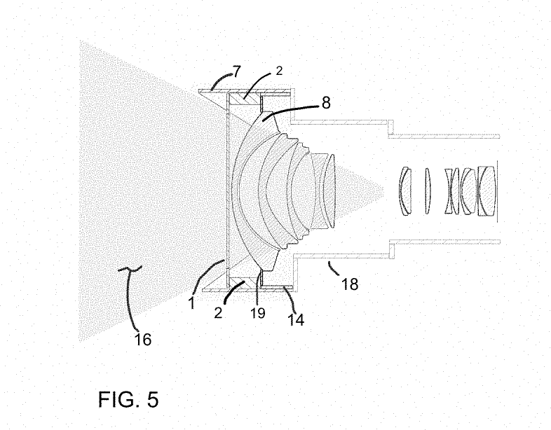

FIG. 5 shows a cut away of an ultra wide angle lens 18 with the apparatus attache in place. You can see the minimal spacing between the substrate 1 and front lens element 8. The front element ring 19 is supported by the ring support 14. In this example, the standoffs 2 land on the front element ring 19 to establish the plane location of the substrate 1.

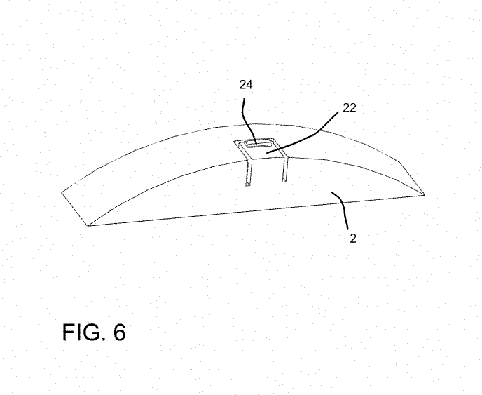

FIG. 6 depicts the second embodiment of standoff where a spring like mechanism is used to create the frictional forces required to hold the apparatus in place. Here the spring 22 is free to move on all sides but one. The side that is attached to the body of the standoff becomes the fulcrum point of the spring. A nub is formed above the arc 24 to provide the area that interferes with inside of the lens hood (two longer scallops) requiring the spring lever to deflect as it is inserted into place within the lens hood.

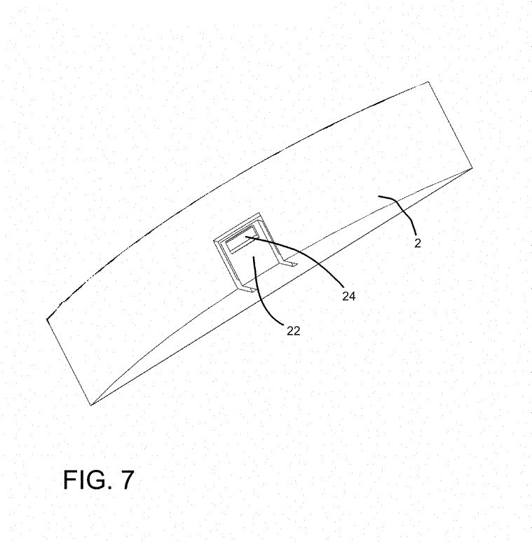

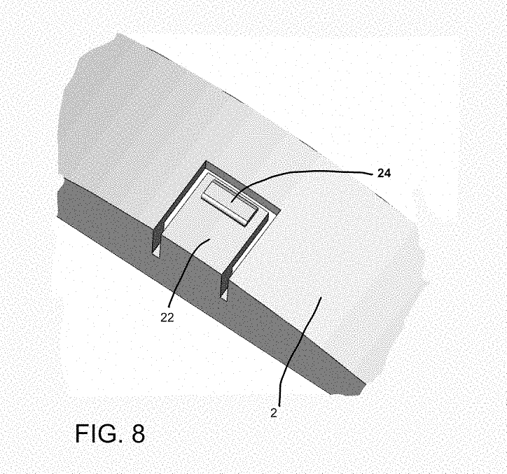

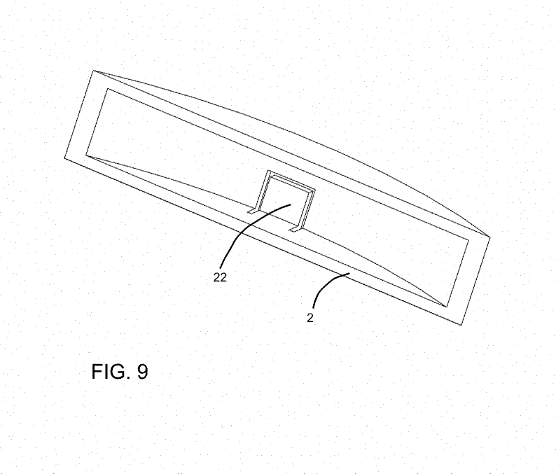

FIG. 7 through FIG. 9 are additional views of the standoff depicted in FIG. 6

To attach the apparatus to the lens, the substrate edges are held by thumb and forefinger, then pressed towards the inside of the lens hood. The stand-offs will start to generate friction with the two longer scallops shown in FIG. 3, item 37 of the lens hood as it goes in towards the lens. The movement towards the lens will be interrupted by the stand-offs 2 hitting the lens body. This will keep the substrate (back plane) from hitting the front lens element .

### First Embodiment of Stand-Off

Adhesive strips, location shown in FIG. 3, 34, with a soft rubberized material on one side and adhesive (such as 3M PSA 3) may be used to achieve just enough friction to hold the filter in place when the lens is faced in a downward direction. Small slits cut lengthwise in the rubber could be used to enhance the friction. This method slightly different thicknesses would be provided to the user allowing them to tailor it to their particular lens and achieve the correct friction.

### Second Embodiment of Stand-Off

In this embodiment, the use of a spring mechanism is employed. This embodiment is best made from a mold injection type of plastic that has good linear elastic deformation. In FIG. 6 the design of this element is shown. It is very similar to the design of a cantilever snap joint in that the protruding section is compressed creating frictional force against the inside of the lens hood.

The material of the stand-offs can be plastic or metal. It is important that the weight is considered and minimized as the force of gravity (from weight of substrate and two stand-offs) can overpower the frictional forces of the stand-off to the inside of the two scallops of the lens hood. This is especially true when the camera lens is facing a downward position.

### Shape And Physical Dimensions of Apparatus

The aspect ratio for image sensors used in most digital cameras are 3×2. The dimensions are approximately 24 mm by 36 mm for full frame, with 36 mm being in the X direction. The dimension for APS-C is approximately 14.8 mm by 22.2 mm with 22.2 mm being in the X direction.

In FIG. 4, you see the shape of the apparatus. In the first view, the substrate has the appearance of a circle with a rectangle superimposed over it, with the rectangle extending beyond the diameter of the circle in the long direction (x direction), but shorter than the diameter of the circle in the short direction (y direction). This shape allows the substrate section to extend beyond the shorter sections of the lens hood shown in FIG. 3, item 39, in 2 places. This provides the necessary coverage in the x direction for a typical 3×2 format sensor.

In FIG. 4, the cross section (side view) shows the positioning of the apparatus when mounted in the lens hood (FIG. 5, item 40). The positioning of the substrate plane is determined by the either the shorter scalloped sections of the lens hood (FIG. 3, item 39, 2 places) or by the protrusion of the front lens element (FIG. 5, item 44). Whichever of these protrudes furthest away from the mounting point of the lens, is the reference. The apparatus is nominally positioned between 1 to 3 mm further away from the mount point of the lens than the reference. This distance along with the position of the part of the lens that holds the front element will determine the length of the standoff.

The width of the filter part of the apparatus (FIG. 4, A) is determined by the minimum amount to provide coverage in the X direction (diameter of the lens hood) plus an extra amount of length to physically handle the apparatus at each end of the X direction when attaching or removing the apparatus from the lens. The amount to handle the apparatus can add between 2 mm to 10 mm additional width to the minimum coverage amount.

The size of the lens hood determines the radius (FIG. 4, r). So in mm, r=[D/2]−1, with D being the inside diameter of the lens hood at the location of the apparatus when mounted in the lens hood.

The thickness of the standoffs (FIG. 4, D), is determined by the field of view at the location of the filter plane, (FIG. 5, 16) at (FIG. 5, 1). This is important as the field of view could be larger than distance between the two standoffs thus causing blockage of the field of view to the image sensor or film. Some lenses may not be suitable when this is the case.

### Manufacturing of Apparatus

The typical method of manufacture for conventional filters is to use float glass, cut the shape of the glass, finish the edges to remove chips, then polish the surfaces of the glass using a dual sided planetary polisher, polyurethane polishing pads, and some type of slurry that is made up with an abrasive material such as cerium oxide (CeO2) or aluminum oxide (Al2O3).

A more cost effective method would be to use a down draw glass for the type of glass. Overflow down draw glasses are formed by molten glass flowing over a trough and down in a sheet form. Some methods use two sides of a trough, flowing over the edge then rejoining. An example of this is Corning's fusion process. Down draw glasses have surfaces that are atomically smooth and very uniform thicknesses and therefore can meet the requirements for this application without the need for grinding and (or) polishing. However, they still have to be cut to the desired shape, and edges finished to remove chips from the cutting. These processes require holding the substrate in a way that would not disturb the atomically smooth surfaces from the down draw process.

One method to minimize the finishing of the edges is to use cut the shape using a femto laser. Femto lasers are a new technology for machining glass. Instead of ablating the surface to create a cut, tiny holes are created at precise intervals, creating an internal stress. The glass cracks along the path of holes, effectively making a cut. The finish of the cut is much smoother than conventional laser ablation methods, and the amount of chipping is negligible. Since most glass failures occur from a propagation point, such as a chip, the chances for failure are much less

1. A camera lens filter apparatus comprising: A planar optical filter, best described of having a shape consisting of a circular geometry combined with a rectangular geometry on the same plane. Where the circular geometry has a diameter that is larger than the y dimension of the rectangle (shorter distance of the rectangle), and the rectangular geometry is centered on the circle but extends beyond, in the x direction, on both sides of the circle.

2. The camera filter apparatus according to claim 1 where the apparatus would have two features (referred here as standoffs) that protrude from the rear of the optical filter towards the lens and create a stop to locate the optical filter plane to position relative to the front element of the lens.

3. The camera filter apparatus according to claim 2 where the standoffs are cut small enough to not effect the image for a 2:3 ratio (typical 35 mm) format.

4. A camera filter apparatus according to claim 3, where standoffs incorporate spring like forces that provide friction against the inside (longer sections) of the lens hood scallops.

5. A camera filter apparatus according to claim 4, where spring like forces are generated by a cantilever type spring.

6. A camera filter apparatus according to claim 5, where a cantilever type spring is created by separation of the cantilever from the body of the standoff on three sides, making the forth side a fulcrum point where stress can be generated.

7. A camera filter apparatus according to claim 6, where a two standoffs attached to the rear planar face of the optical filter apparatus would have a diameter slightly smaller than that of the inside diameter of the lens hood. Nubs placed at the top of the two standoff cantilevers would increase the overall diameter in the y direction of the camera filter apparatus, creating an interference fit. The cantilever and nubs would yield when the filter apparatus is placed in the lens hood. The compression of the cantilevers and nubs create stress in the material at the fulcrum point of the cantilever or spring. This spring like force creates friction with the inside of the lens hood and holds the filter apparatus in place.

8. A camera filter apparatus according to claim 4, by where the spring like forces are created by the use of a compressible material. The material, placed on the outer edges of the standoffs creating a larger physical diameter than that lens hood inside diameter. As the filter apparatus is placed into the lens hood, the compressible material compresses, creating frictional forces enough to hold the filter apparatus in place.

9. A camera filter apparatus according to claim 8, where the compressible material has an pressure sensitive adhesive on one side to adhere it to the standoff.
